(19) United States
(12) Patent Application Publication
(10) Pub. No.: US 2015/0033184 A1
(43) Pub. Date: Jan. 29, 2015

(54) METHOD AND APPARATUS FOR EXECUTING APPLICATION IN ELECTRONIC DEVICE

(71) Applicant: Samsung Electronics Co., Ltd., Suwon-si (KR)

(72) Inventors: Jeongseob KIM, Daegu (KR); Jinwan AN, Daegu (KR); Jiwoong OH, Seoul (KR)

(21) Appl. No.: 14/338,780

(22) Filed: Jul. 23, 2014

(30) Foreign Application Priority Data
Jul. 25, 2013 (KR) 10-2013-0087817

(51) Int. Cl. G06F 3/0484; G06F 3/0482

(52) U.S. Cl. CPC G06F 3/04842; G06F 3/0482
USPC 715/808; 715/841

(57) ABSTRACT

A method and apparatus for displaying an application in a mobile terminal are provided. The method includes executing an application in a mobile terminal may include displaying icons corresponding to at least one application on a menu screen, extracting associated applications previously designated to have the same category as that of an application corresponding to a selected icon when the icon is selected in the menu screen, displaying at least one associated icon corresponding to the extracted associated application in an associated icon list form, and executing an application corresponding to the at least one associated icon when the at least one associated icon is selected in the associated icon list.

### CROSS-REFERENCE TO RELATED APPLICATION(S)

This application claims the benefit under 35 U.S.C. §119(a) of a Korean patent application filed on Jul. 25, 2013 in the Korean Intellectual Property Office and assigned Serial number 10-2013-0087817, the entire disclosure of which is hereby incorporated by reference.

### TECHNICAL FIELD

The present disclosure relates to a method and apparatus for executing an application in a mobile terminal. More particularly, the present disclosure relates to a method and apparatus for displaying and executing applications associated with a selected application.

### BACKGROUND

The types of applications stored in a mobile terminal have been diversified, and the number of applications has been increased. Accordingly, the number of pages of a menu screen on which the icons of applications are displayed has also increased. When the icons of applications stored in a mobile terminal are displayed on the menu screen, the icons are simply arranged in order of names, installation, and the like. The arranged icons may be displayed one by one, or icons desired by a user may be grouped and displayed in a folder form.

In a menu screen including a plurality of pages, a user has to perform page turning several times in order to select an icon corresponding to an application to be executed or select an icon corresponding to a desired application in a folder in which icons are grouped. Consequently, a user may suffer an inconvenience in finding a desired icon in a plurality of icons or a folder including a group of icons.

Accordingly, a method and apparatus for displaying all applications associated with an application corresponding to a selected icon when the selection of the icon corresponding to the application is detected in a page that is now displayed on a menu screen including several pages in a mobile terminal is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure may provide a method and apparatus for displaying all applications associated with an application corresponding to a selected icon when the selection of the icon corresponding to the application is detected in a page that is now displayed on a menu screen including several pages in a mobile terminal.

In accordance with an aspect of this disclosure, a method of executing an application in a mobile terminal is provided. The method includes displaying icons corresponding to at least one application on a menu screen, extracting associated applications previously designated to have the same category as that of an application corresponding to a selected icon when the icon is selected in the menu screen, displaying at least one associated icon corresponding to the extracted associated application in an associated icon list form, and executing an application corresponding to the at least one associated icon when the at least one associated icon is selected in the associated icon list.

In accordance with another aspect of this disclosure, an apparatus for executing an application in a mobile terminal is provided. The apparatus includes a display panel configured to display a menu screen and an associated icon list, a touch panel configured to detect a user input for displaying the associated icon list in the menu screen, and a control unit configured to extract associated applications by analyzing the category of a selected application when a user input for displaying the associated icon list to display icons corresponding to the extracted associated applications in the form of the associated icon list, and to execute an application corresponding to a selected icon when the associated icon is selected in the associated icon list.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating the construction of a mobile terminal according to an embodiment of the present disclosure;

FIG. 2 is a flowchart illustrating a procedure of displaying applications associated with a selected application according to an embodiment of the present disclosure;

FIGS. 3A, 3B, 3C, 3D, 3E, 3F, 3G, and 3H are diagrams illustrating examples in which associated applications of FIG. 2 are displayed according to an embodiment of the present disclosure; and

FIG. 4 is a flowchart illustrating a procedure of designating a category for displaying the associated application of FIG. 2 according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The menu screen of an electronic device according to various embodiments of the present disclosure is a screen on which application icons corresponding to applications or folders in each of which several icons are grouped are displayed. The menu screen may include one or more pages. In each page of the menu screen, application icons or folders may be simply arranged in order of an alphabet or the alphabet of the user, installation date, and the like. Furthermore, as the number of applications installed in a mobile terminal increases, the number of displayed application icons may increase. As a result, the number of pages that form the menu screen may increase. In the following description, the menu screen is assumed to be a home screen, an applications screen, and/or a task administrator screen.

In various embodiments of the present disclosure, an icon corresponding to an application may be an icon corresponding to each application or may be a folder in which one or more icons corresponding to an application are grouped according to a user's intention.

In various embodiments of the present disclosure, each application stores information about its unique category. In various embodiments of the present disclosure, associated applications in a mobile terminal in which various types of applications are stored may be designated to have the same category. That is, the category may be used as a term for classifying applications that perform associated functions. For example, ‘bank’, ‘investment’, and ‘stock’ applications may be stored as a ‘finance’ category. For another example, various types of portal site applications may be stored as a ‘browser’ category. In this case, the category, such as ‘finance’ or ‘browser’, may be described as each category field.

The categories of applications may be classified and designated in an application market, or a user may change and designate the categories of downloaded applications. Current categories classified in application markets are not subdivided, but are designated in a wide range. Accordingly, a user may subdivide and designate the category fields of applications stored in a mobile terminal. Furthermore, a user may set an associated application relationship by grouping some associated applications into the same category. Thereafter, when the associated applications are displayed, they may be displayed as applications belonging to the same category.

In the present disclosure, it is assumed that an associated icon list display function has been activated in a user setting operation.

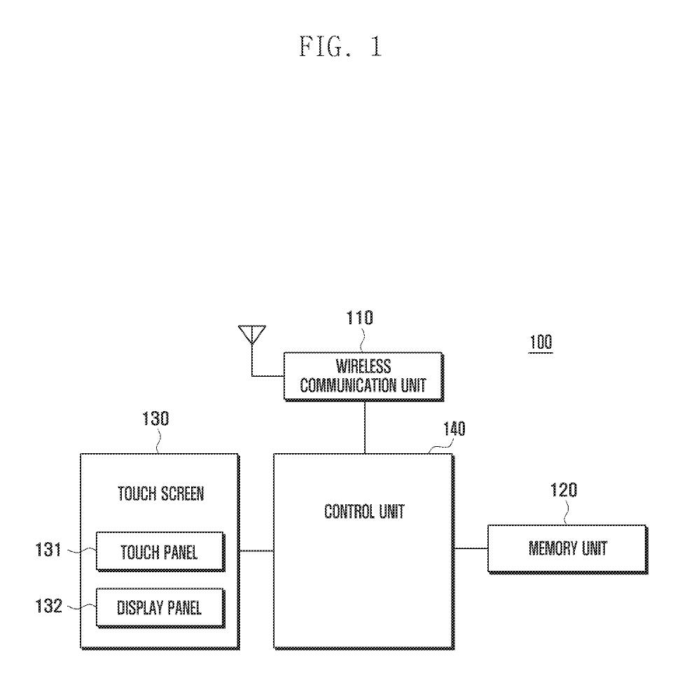

FIG. 1 is a diagram illustrating the construction of a mobile terminal according to an embodiment of the present disclosure.

Referring to FIG. 1, the mobile terminal 100 may be configured to include a wireless communication unit 110, a memory unit 120, a touch screen 130, and a control unit 140, but is not limited thereto.

The wireless communication unit 110 performs voice calls, video telephony, or data communication with an external device over a network under the control of the control unit 140. The wireless communication unit 110 includes a radio frequency transmission unit for performing up-conversion and amplification on the frequency of a transmitted signal and a radio frequency reception unit for performing low-noise amplification and down-conversion on the frequency of a received signal. Furthermore, the wireless communication unit 110 includes a mobile communication module (e.g., CDMA, LTE, or WCDMA), a digital broadcasting module (e.g., a DMB module), short distance communication modules (e.g., a Wi-Fi module, a Bluetooth module, and a Near Field Communication (NFC) module). Furthermore, the wireless communication unit 110 may perform data communication between an application market and the mobile terminal when a user downloads an application from the application market.

The memory unit 120 may include program memory for storing the operating program of the mobile terminal and programs in accordance with an embodiment of the present disclosure and data memory for storing data for the operations of the mobile terminal. Furthermore, the memory unit 120 stores applications downloaded by a user and may also store icons corresponding to applications and pieces of category information. The touch screen 130 may be configured to include a touch panel 131 and a display panel 132. The touch panel 131 may be integrally formed with the display panel 132. Furthermore, the touch panel 131 may detect a touch input and transfer a detected touch signal to the control unit 140. Furthermore, the touch panel 131 may detect a user input for displaying associated applications.

The display panel 132 may include a Liquid Crystal Display (LCD), Organic Light Emitted Diodes (OLED), or Active Matrix Organic Light Emitted Diodes (AMOLED). Furthermore, the display panel 132 displays a menu screen and displays a list of applications associated with an application selected in the menu screen.

The control unit 140 may control the overall operation of the mobile terminal 100. Furthermore, the control unit 140 may detect an event for selecting an icon corresponding to an application in a menu screen including a plurality of pages. The control unit 140 displays a list of icons associated with the selected icon. The associated icon list may be displayed in a newly generated window. In order to display the associated icon list, the control unit 140 may analyze the category of the selected icon and extract applications, having the same category, as associated applications. Thereafter, the control unit 140 may display one or more icons, corresponding to the associated applications, in an associated icon list form and execute a selected application when the selection of the associated icon is detected.

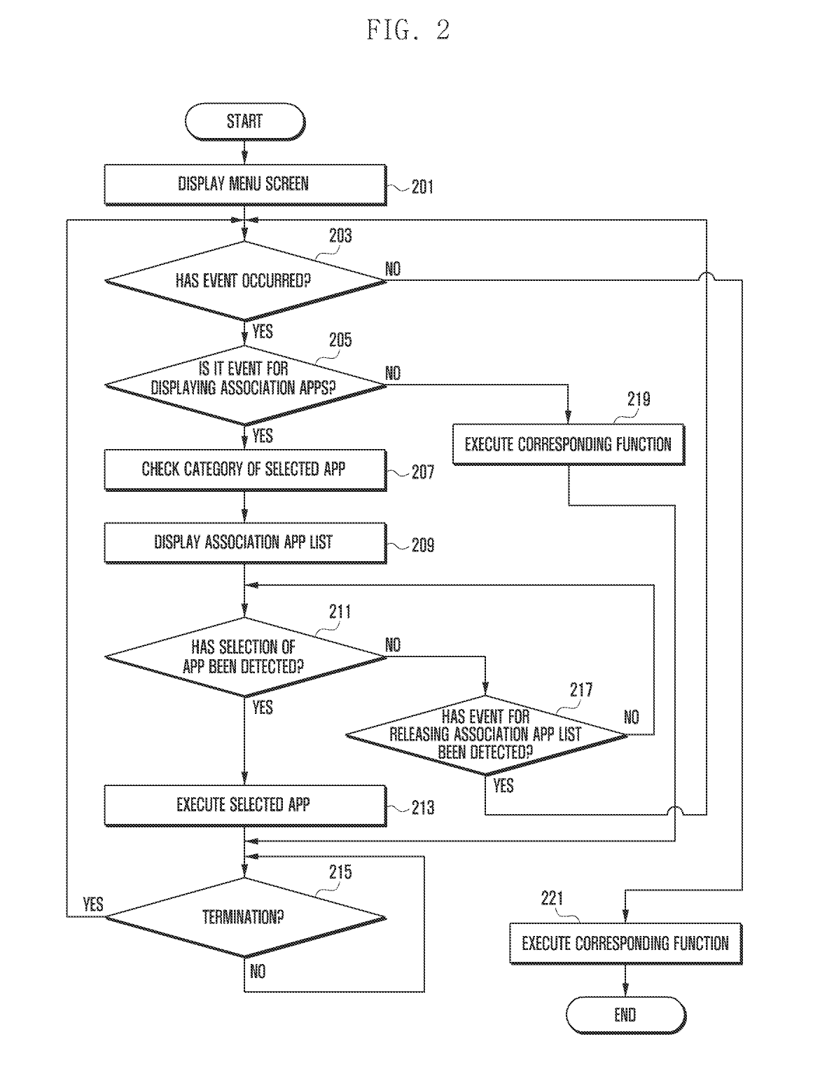

FIG. 2 is a flowchart illustrating a procedure of displaying applications associated with a selected application in a mobile terminal according to an embodiment of the present disclosure.

Referring to FIG. 2, the control unit 140 may display a menu screen on the display panel 132 at operation 201. In this case, the menu screen may include one or more pages and may be a screen on which icons corresponding to applications are displayed. The menu screen may be a home screen, a widget screen, and/or a task administrator screen.

In the state in which the menu screen has been displayed, the control unit 140 may detect a user input in which a user selects an icon corresponding to an application at operation 203. When the user input is detected, the control unit 140 determines whether or not the detected user input is a user input for displaying associated applications at operation 205. In this case, the user input for displaying associated applications may be a user input, such as a long touch, a pinch zone, or an event that presses the button of a touch pen, but the present disclosure is not limited thereto. In the following description, the user input for displaying associated applications is assumed to be a long touch.

When the user input (e.g., a long touch) for displaying associated icon list is detected, the control unit 140 checks the category of the selected application by analyzing the selected application at operation 207. In this case, the category may be a category designated when the selected application is downloaded or may be a category changed by a user. When the control unit 140 does not detect user input for displaying associated applications at operation 205, executed the corresponding function at operation 219.

The category may be stored in the memory unit 120 of the mobile terminal in the following form, but the present disclosure is not limited thereto.

TABLE 1

| ID | APPLICATION | CATEGORY |
|---|---|---|
| 1 | First bank | Finance |
| 2 | First game | Game |
| 3 | Second game | Game |
| 4 | First cartoon | Cartoon |
| | application | |
| 5 | First portal site | Browser |
| 6 | Navigator | Transportation |
| 7 | Bus route map | Transportation |
| 8 | Subway | Transportation |
| | application | |
| 9 | Second portal site | Browser |
| 10 | Second bank | Finance |
| 11 | Third bank | Finance |
| 12 | Fourth bank | Finance |
| 13 | Fifth bank | Finance |
| 14 | Third game | Game |
| 15 | Fourth game | Game |
| 16 | Second cartoon | Cartoon |
| | application | |
| 17 | Third portal site | Browser |
| 18 | Fourth portal site | Browser |
| 19 | First camera | Photograph |
| 20 | Second camera | Photograph |
| 21 | Second weather | Weather |
| . . . | . . . | . . . |

Thereafter, the control unit 140 may display an associated icon list corresponding to corresponding to icon of the selected application at operation 209. In this case, the associated icon list may be displayed in a newly generated window. The window may be displayed in various forms. For example, the window may be overlaid and displayed in a pop-up form on the menu screen, a window displayed on part of the wallpaper, or a window in which the menu screen including the associated icon list is displayed on a new execution screen. In this case, the window displayed on the new execution screen may be displayed over the wallpaper on a screen having a layer different that of the wallpaper. When displaying an associated icon list, if associated icons have the same category, the control unit 140 determines that the associated icons are icons corresponding to associated applications. In this case, the associated icon list may include an icon corresponding to one or more applications. In this case, the control unit 140 may extract the icons of applications having the same category by analyzing the categories of all the applications that form the menu screen and display the extracted icons in the form of a list. That is, the menu screen may include one or more pages, and the icons of the applications having the same category may be disposed in the same page or different pages. Accordingly, when an icon is selected in a specific page of a displayed menu screen, the control unit 140 checks the categories of applications disposed in the same page and different pages and displays images of the icons of applications having the same category as the application of the selected icon.

Furthermore, the control unit 140 may display the application icons having the same category in a pop-up form.

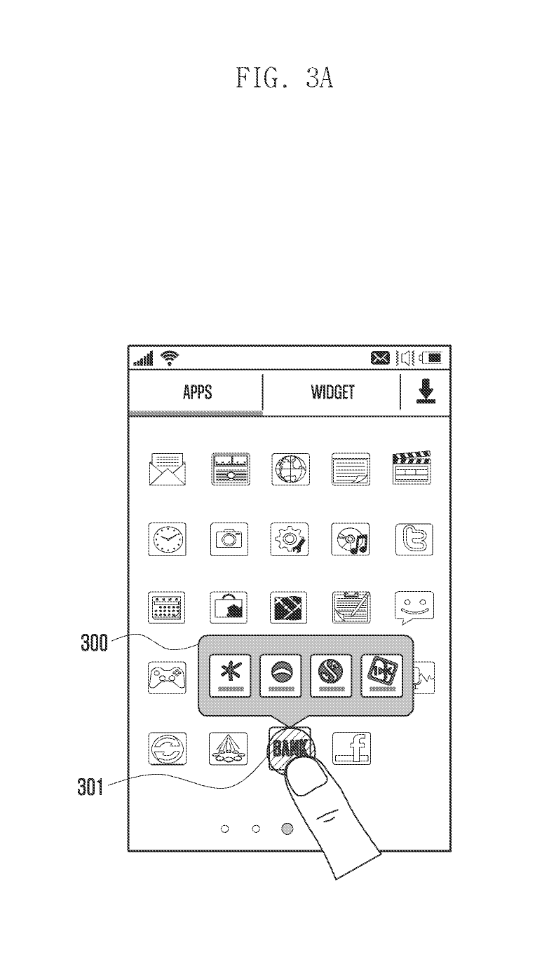

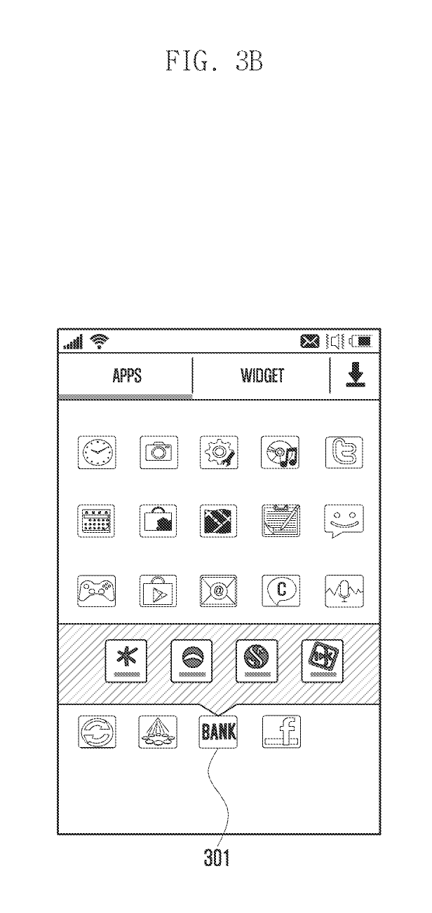

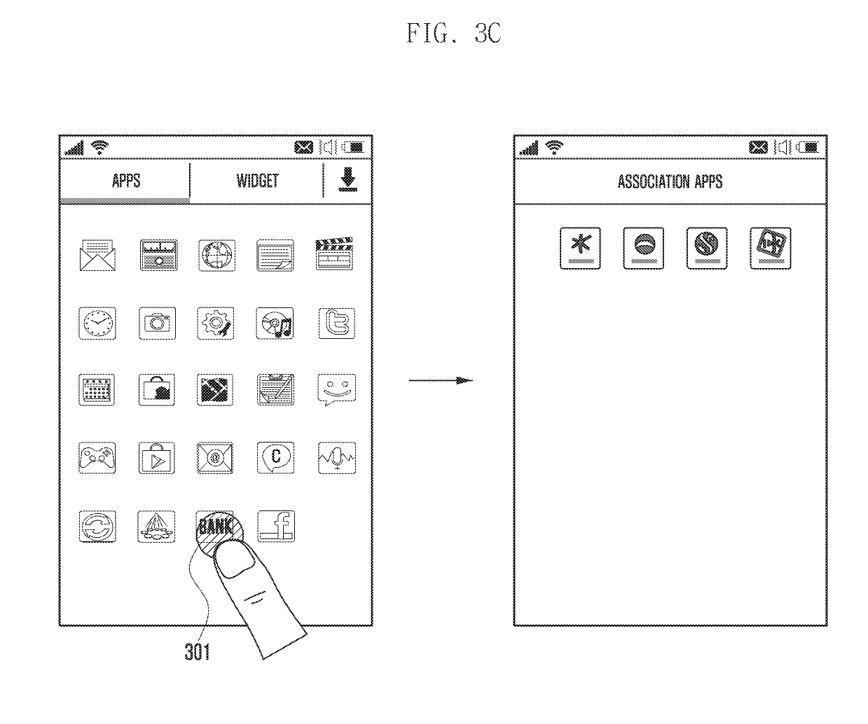

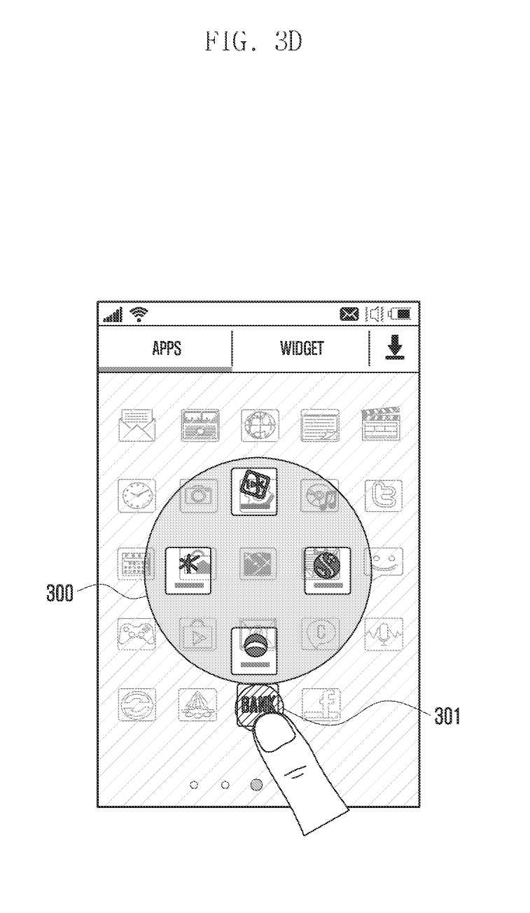

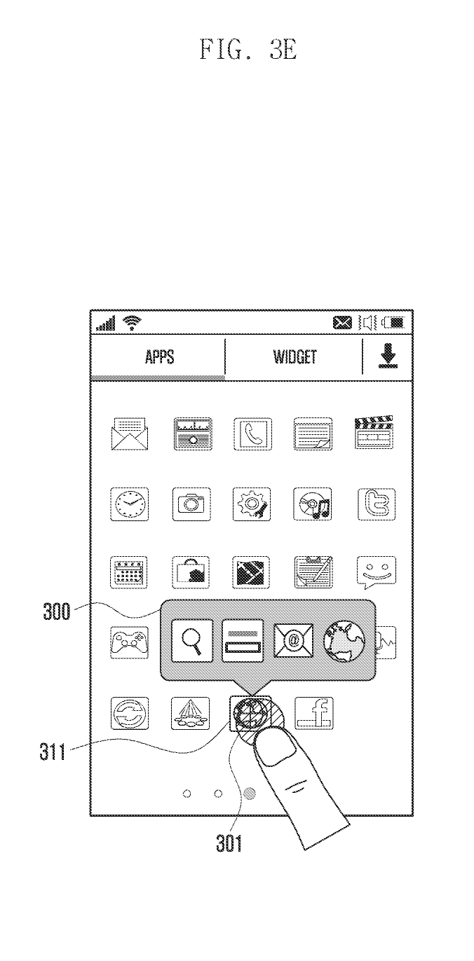

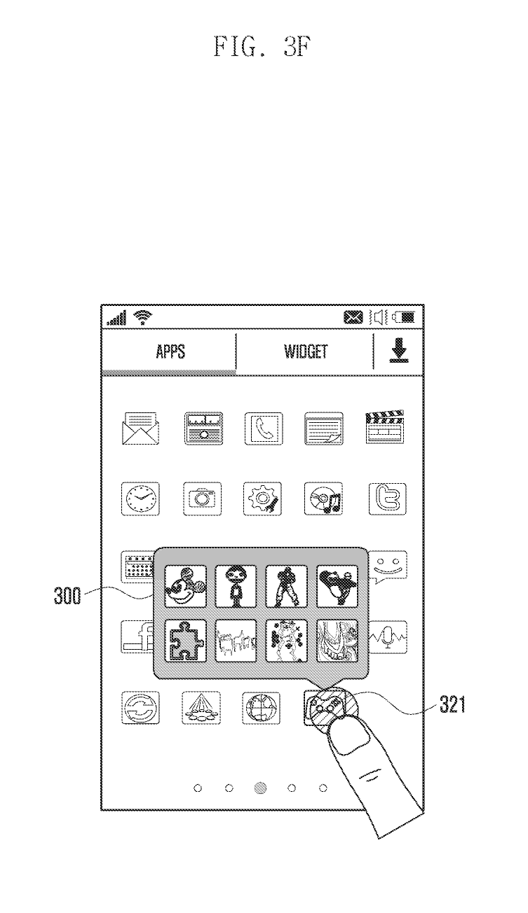

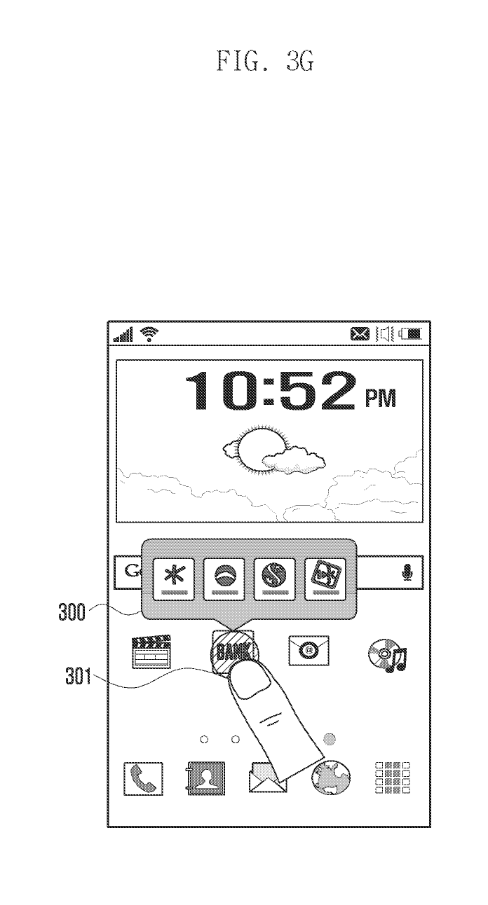

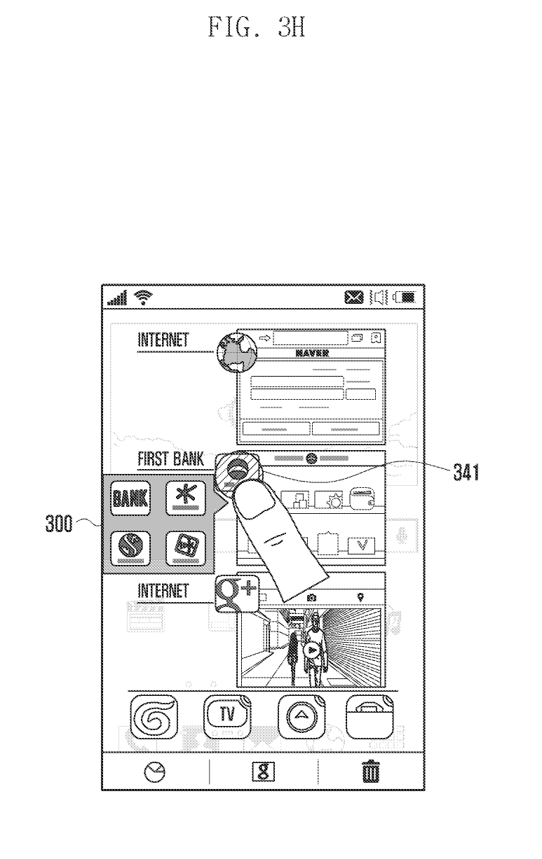

FIGS. 3A to 3H are diagrams illustrate examples in which the associated application of FIG. 2 is displayed according to an embodiment of the present disclosure.

Referring to FIG. 3A, an example in which associated icon list are displayed if a menu screen is an applications screen according to an embodiment of the present disclosure is illustrated. In this case, the menu screen (e.g., the applications screen) may include one or more pages, and the third of the one or more pages is assumed to be displayed. Application icons may be arranged in the menu screen (e.g., the applications screen) collectively or randomly. The application icons may be arranged in order of the English alphabet or the alphabet of the user, installation, or frequently executed applications. In this case, the application icons may be icons corresponding to various types of applications or a folder in which the icons are grouped.

In the state in which the application icons have been arranged, the control unit 140 may detect a user input (e.g., a long touch) event at the position of a specific icon 301. In this case, the control unit 140 may determine the event for selecting the specific icon to be an event for displaying associated applications. The specific icon is assumed to be a first bank application icon. Referring to Table 1, the first bank application is stored in a finance category field in the memory unit 120. In this case, the control unit 140 may analyze the finance category field and display the associated icon list corresponding the associated application, stored in the finance category, in a newly generated window, such as that indicated by 300 of FIG. 3A. The newly generated window may be displayed in various forms. For example, the newly generated window may be overlaid and displayed in a pop-up form on the menu screen. For another example, in the newly generated window, an associated icon list may be displayed in some space of the wallpaper, or the associated icon list may be displayed on a new execution screen. In this case, the associated icon list may have the same category in icons corresponding to applications that are disposed in the same page or different pages. Accordingly, application icons having the same category may be arranged (e.g., in the form of the pop-up 300) and displayed in the associated icon list.

Referring to FIG. 3B, the control unit 140 may display a window in which the associated icon list is displayed on part of the wallpaper is illustrated.

Referring to FIG. 3C, when the selection of a specific icon 301 corresponding to an application is detected, the control unit 140 may display the associated icon list of the selected icon on a new execution screen is illustrated. In this case, the new execution screen may be a screen having a layer different from that of the wallpaper on which an existing menu screen is displayed.

Referring to FIG. 3D, an example in which associated icon list are displayed. When displaying an associated icon list, a pop-up form may be displayed in a circle as indicated by 300 of FIG. 3D. In the pop-up form, the shape, transparency, and size of a pop-up window and the number of application icons displayed at once in the pop-up window may be set in various ways according to a user′ setting. A process of detecting a user input (e.g., a long touch) and displaying the pop-up window in FIG. 3B is the same as that of FIG. 3A, and thus a description thereof is omitted.

Referring to FIG. 3E, an example of a screen if the category field of an associated application is a browser when detecting a user input (e.g., a long touch) for displaying the associated application as the associated icon list in a menu screen (e.g., an applications screen) is illustrated. If the category field of an associated application is a browser, the associated application may be displayed in the same manner as that if the category of an associated application is finance. One or more portal site applications are stored in the browser category of the memory unit 120. In this case, the categories of the applications stored in the browser category may have been stored based on the classification of an application market when the applications are downloaded or may be changed by a user after the applications were downloaded. In the state in which a menu screen (e.g., an applications screen) including one or more pages has been displayed, the control unit 140 may detect a user input (e.g., a long touch). The user input may be a event for displaying the associated icon list. Thereafter, the control unit 140 may determine an application icon on which the long touch has been performed and display a corresponding associated application. If the application icon from which the user input has been detected is determined to be a ‘first portal site’ 311, the control unit 140 may analyze category information stored in the application icon ‘first portal site’ 311. The control unit 140 may determine that the application icon ‘first portal site’ 311 has been stored in a browser category. Thereafter, the control unit 140 may extract application icons having the browser category that are disposed in the same page or different pages and display icons, corresponding to the extracted application icons, in the form of an associated icon list. For example, the associated icon list may be displayed in a pop-up form as indicated by 300 of FIG. 3D.

Referring to FIG. 3F, an example of a screen on which an associated icon list is displayed on a menu screen (e.g., an applications screen) including a plurality of pages is illustrated. In the state in which the menu screen (e.g., the applications screen) has been displayed, the control unit 140 may detect a user input event (e.g., a long touch). Thereafter, the control unit 140 may determine whether or not the user input is an event for displaying icons corresponding to associated applications. Furthermore, the control unit 140 may check the category of an specific icon 321 corresponding to an application from which a user input has been detected and display application icons associated with the application icon in the form of an associated icon list. In this case, icons corresponding to an application displayed in the form of the associated icon list may be disposed in the same page or different pages. When displaying the associated icon list, the control unit 140 may arrange and display the application icons in a pop-up form by taking the number of application icons into consideration. For example, if the number of icons corresponding to associated applications is 8, a displayed associated icon list may be displayed in two lines as indicated by 300 of FIG. 3F. The associated icon list may be displayed in a newly generated window. For example, the newly generated window may be displayed on the menu screen in a pop-up form, may be displayed on part of the wallpaper, or may be displayed on a new execution screen.

Referring to FIG. 3G, an example of a screen on which an associated icon list is displayed if a menu screen is the wallpaper is illustrated. The control unit 140 may detect a user input in a menu screen (e.g., the wallpaper) including one or more pages. In this case, the control unit 140 analyzes the category of an application from which the user input has been detected. Furthermore, the control unit 140 may display an associated icon list, including icons corresponding to applications stored in the same category, in a newly generated window. When a user input for displaying an associated icon list is detected in the menu screen (e.g., wallpaper) including one or more pages as described above, the control unit 140 may display icons, corresponding to applications stored in the same category, in the form of an associated icon list (e.g., a pop-up window 300). In this case, the applications stored in the same category may be disposed in the same page or different pages.

Referring to FIG. 3H, an example of a screen on which an associated icon list is displayed if a menu screen is a task administrator screen is illustrated.

When a task administrator is executed, the control unit 140 displays recently executed applications sequentially. For example, referring to FIG. 3F, the mobile terminal 100 has a record of a first portal site application, a first bank application, and a second portal site application that have been sequentially used. In such a state, when a user input is detected in a first bank application icon 341, the control unit 140 determines whether or not the user input is an event for displaying associated applications. Thereafter, the control unit 140 checks category information stored in the first bank application. If, as a result of the check, the category of the first bank application is determined to be ‘finance’, the control unit 140 may display icons corresponding to the application of the ‘finance’ category, disposed in the same page or different pages, in the form of an associated icon list. In a pop-up window 300 in which the associated icon list is displayed, application icons including the same category information may be displayed in a lattice pattern as indicated by 300 of FIG. 3H. The associated icon list is not limited to the pop-up form, but may be displayed on part of the wallpaper or on a new execution screen.

In the state in which the associated icon list has been displayed according to various embodiments as described above, when the selection of an icon in the associated icon list is detected at operation 211, the control unit 140 may execute an application corresponding to the selected icon at operation 213. Thereafter, when the termination of the application being executed is detected at operation 215, the control unit 140 may terminate the application being executed and branch to operation 203 in which the control unit 140 may check whether or not an event is generated. If the termination of the application being executed is not detected at operation 215, the control unit 140 performs control so that the application being executed continues to be executed.

If the selection of an icon corresponding to the application is not detected at operation 211, the control unit 140 checks whether or not an event for releasing the display of the associated icon list has been generated at operation 217. In this case, the event for releasing the associated icon list may be an event (e.g., a tap) that is generated at a point other than a region displayed in a pop-up form and may correspond to an event for selecting a close button displayed in the associated icon list. If, as a result of the check at operation 217, an event for releasing the associated icon list is found to be not detected, the control unit 140 branches to operation 211 in which the control unit 140 checks whether or not the selection of an icon is detected. If, as a result of the check at operation 217, an event for releasing the associated icon list is found to be detected, the control unit 140 branches to operation 203 in which the control unit 140 may check whether or not an event is generated. Thereafter, the control unit 140 may perform control so that the aforementioned procedure is performed. Furthermore, when a request for terminating the application being executed is detected at operation 215, the control unit 140 may terminate the execution of the application and branch to operation 203 in which the control unit 140 may check whether or not an event is generated. If the generation of an event is not detected for a specific time in the state in which the menu screen has been displayed at operation 203, the control unit 140 may branch to operation 221 in which the control unit 140 may perform control so that the menu screen is turned off. In this case, the specific time may be time set in a user setting operation.

As described above, the mobile terminal according to various embodiments of the present disclosure may detect the generation of a user input event in a menu screen including one or more pages. Furthermore, if an associated icon list display function is activated, the control unit 140 determines whether or not the detected event is a user input (e.g., a long touch) for displaying associated applications. If the detected event is an event for displaying associated applications, the control unit 140 may display a selected and detected application and an associated icon list (e.g., in a pop-up form). Accordingly, a user may execute an application to be actually executed in a menu screen including one or more pages without performing page turning several times in order to search for an icon corresponding to the application because an associated icon list is displayed.

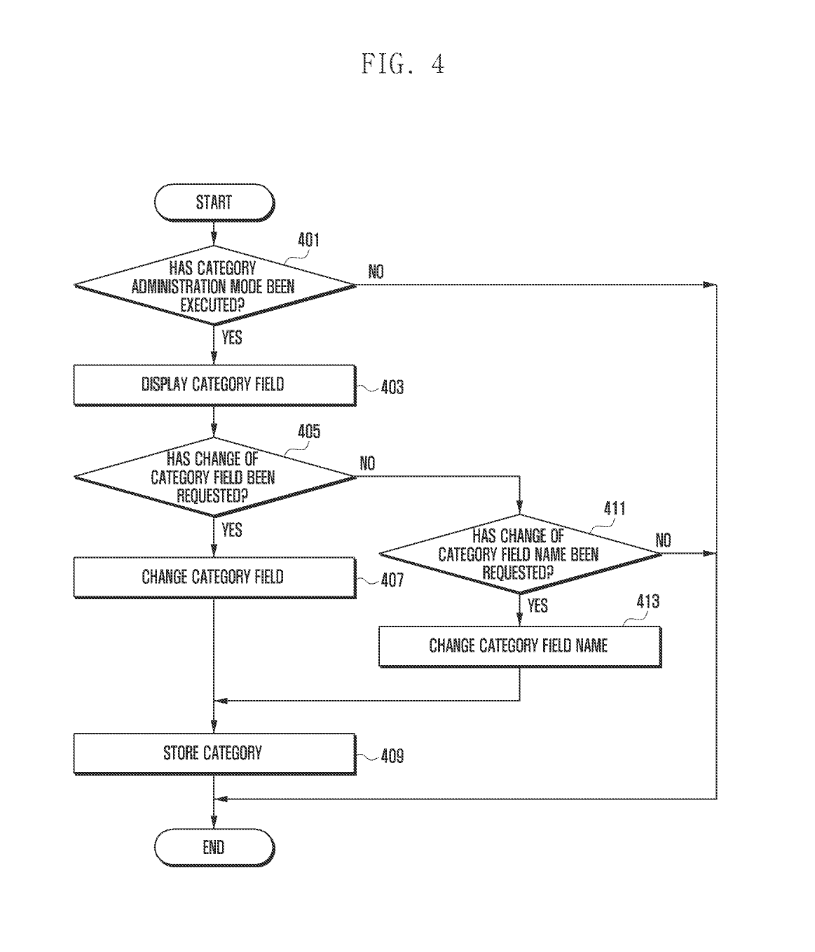

FIG. 4 is a flowchart illustrating a procedure of designating a category for displaying the associated application in FIG. 2 according to an embodiment of the present disclosure.

Referring to FIG. 4, if a category administration mode is detected to be an execution mode at operation 401, the control unit 140 may arrange and display the fields of the categories of downloaded applications in the category administration mode at operation 403. When executing the category administration mode, the control unit 140 may display various types of category fields and application icons corresponding to the category fields. In this case, the category administration mode may be executed in a user setting operation or may be executed at operation of downloading applications. The categories of applications have been basically classified and stored in an application market. For example, the categories of applications may be classified as follows in an application market. In an application market, the categories of applications may be classified in a wide area, for example, game, health and exercise, education, transportation, finance, weather, news and magazines, decoration, tools, books and reference data, live background screens, library and demo, life styles, cartoons, media and moving images, business, photographs, productivity, social content, shopping, sports, entertainment, travel and local information, widgets, music and audio, medical care, and communication.

In the state in which the category fields have been displayed in the category administration mode, the control unit 140 selects an icon corresponding to a specific application. When a category field change request for the specific app is detected at operation 405, the control unit 140 changes the category field at operation 407 and stores the specific application in the changed category field at operation 409. In this case, the category field may be a category, such as game, health and exercise, or education. The category field change request may be a gesture (e.g., a drag) for selecting (e.g., tapping) an icon corresponding to an application whose category field will be changed and moving the icon to a category field to be changed. For example, the category field change request may correspond to a change from a first game application icon, designated as a game category, to a life style category. The category field change request may correspond to an operation for moving an icon in the state in which a category field has been displayed on the left and the icon corresponding to an application corresponding to the category field has been displayed on the right. Furthermore, the category field change request may correspond to an operation for displaying an icon corresponding to a category field and moving the icon when the category field is selected in the state in which the category field has been displayed in a folder form. As described above, the control unit 140 may form an associated relationship between associated applications by grouping icons corresponding to the associated applications.

When a category field name change request for the specific application from a user is detected at operation 411, the control unit 140 changes the name of a category field of the specific application at operation 413 and stores the changed category at operation 409. In this case, the category field name change request may correspond to a gesture (e.g., a tap) for selecting a region in which the name of the category field is displayed. When the gesture is detected, the control unit 140 may change the name of a category field of the specific application. That is, the control unit 140 may perform control so that the name of the category field is changed. Accordingly, the control unit 140 may form an associated relationship between associated applications for a user convenience.

As described above, in accordance with various embodiments of the present disclosure, the mobile terminal may detect a user input (e.g., a long touch) for displaying associated applications in a menu screen that is now displayed. In this case, if an associated icon list display function has been activated, the control unit 140 analyzes an application from which the user input (e.g., a long touch) for displaying the associated application has been detected. When analyzing the application from which the user input for displaying the associated application has been detected, the control unit 140 determines that an application belonging to the same category is an associated application by checking the category of the application. In this case, the category of the application may be a category that has been stored based on the classification of an application market. Alternatively, the category of the application may be a category that has been changed in a category administration mode in a user setting operation after the application was downloaded. After analyzing the category of the selected application, the control unit 140 may display a list of associated applications stored in the same category as that of the selected application. Thereafter, when the selection of an application in the associated icon list is detected, the control unit 140 may directly execute the selected application. Accordingly, when a user selects an application having associated with an application to be executed by the user in a menu screen including a plurality of pages without performing page turning several times, the control unit 140 displays an associated icon list and directly executes an application corresponding to an icon selected in the associated icon list. Accordingly, the number of processes for accessing an application to be actually executed may be significantly reduced.

The mobile terminal in accordance with an embodiment of the present disclosure may extract applications associated with an application corresponding to a selected icon when the selection of the icon corresponding to the application is detected in a menu screen on which the icons of applications are displayed and display the extracted applications in the form of an associated icon list. Thereafter, when the selection of an icon is detected, the mobile terminal may execute an application corresponding to the selected icon.

Accordingly, a user may execute an application to be used in an associated icon list by selecting an icon corresponding to an application associated with the application to be used in a menu screen that is now displayed without a need to perform page turning several times in order to search for the icon corresponding to the application to be actually executed. Accordingly, the number of processes for accessing the application to be actually executed can be significantly reduced.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of executing an application in a mobile terminal, the method comprising:
displaying icons corresponding to at least one application on a menu screen;
extracting associated applications previously designated to have a category identical with an application corresponding to a selected icon when the icon is selected in the menu screen;
displaying at least one associated icon corresponding to the extracted associated applications in an associated icon list form; and
executing an application corresponding to the at least one associated icon when the at least one associated icon is selected in the associated icon list.

2. The method of claim 1, wherein the category is designated when the application is generated, and
wherein a category of a downloaded application is changeable by a user.

3. The method of claim 1, wherein the displaying of the at least one associated icon in the associated icon list form comprises:
extracting associated applications having an identical category from applications disposed on an identical page and different pages; and
displaying the extracted associated applications.

4. The method of claim 1, wherein the displaying of the at least one associated icon in the associated icon list form comprises:
extracting associated applications having an identical category; and
displaying at least one associated icon, corresponding to the extracted associated applications, in a newly generated window.

5. The method of claim 4, wherein the newly generated window is overlaid and displayed in a pop-up form on the menu screen, and
wherein the associated icon list is displayed on the newly generated window.

6. The method of claim 4, wherein in the newly generated window, the associated icon list is displayed on part of the menu screen.

7. The method of claim 4, wherein the newly generated window comprises the associated icon list and displays the associated icon list on a new execution screen.

8. The method of claim 1, wherein the icon is selected by a user input in the menu screen.

9. The method of claim 1, wherein the menu screen comprises at least one page, and
wherein the menu screen comprises one of a home screen, an application screen, and a task administrator screen.

10. The method of claim 1, wherein the displaying of the at least one associated icon in the associated icon list form comprises:
displaying the menu screen when an event for releasing an associated icon list is detected.

11. The method of claim 10, wherein the event for releasing the associated icon list is one of detected at a point other than a region in which the associated icon list has been displayed and executed when an event for selecting a list close button formed in the associated application list is detected.

12. An apparatus for executing an application in a mobile terminal, the apparatus comprising:
a display panel configured to display a menu screen and an associated icon list;
a touch panel configured to detect a user input for displaying the associated icon list in the menu screen; and
a control unit configured to extract associated applications by analyzing a category of a selected application when a user input for displaying the associated icon list, to display icons corresponding to the extracted associated applications in a form of the associated icon list, and to execute an application corresponding to a selected icon when the associated icon is selected in the associated icon list.

13. The apparatus of claim 12, wherein the control unit controls the category so that the category is identical with a category of the associated applications and controls a category of a downloaded application so that the category is changed by a user.

14. The apparatus of claim 12, wherein the control unit controls the menu screen so that the menu screen comprises at least one page and controls icons corresponding to applications disposed in one of an identical page and different pages so that the icons are displayed in the form of the associated icon list when a user input for displaying the associated applications is detected.

15. The apparatus of claim 14, wherein the control unit controls the associated applications so that the associated applications have an identical category.

16. The apparatus of claim 15, wherein the control unit displays the associated icon list when a user input for selecting the icon corresponding to the application in the menu screen is detected and displays the associated icon list in a newly generated window.

17. The apparatus of claim 16, wherein the control unit performs control so that the newly generated window is overlaid and displayed in a pop-up form on the menu screen, the associated icon list is displayed in one of part of the menu screen and a new execution screen.

18. The apparatus of claim 17, wherein the control unit controls the menu screen so that the menu screen is displayed when a request for releasing the associated icon list is detected at a point other than a region in which the associated icon list has been displayed or when a request for selecting a list close button displayed in the associated icon list is detected.

19. A non-transitory computer-readable storage medium storing instructions that, when executed, cause at least one processor to perform the method of claim 1.
